(19) United States
(12) Patent Application Publication
(10) Pub. No.: US 2018/0211288 A1
(43) Pub. Date: Jul. 26, 2018

(54) ONLINE WEDDING COORDINATION MARKETPLACE

(71) Applicant: Kip Raymond Sawdy, Jackson, WY (US)

(72) Inventor: Kip Raymond Sawdy, Jackson, WY (US)

(21) Appl. No.: 15/414,527

(22) Filed: Jan. 24, 2017

(51) Int. Cl. G06Q 30/02; G06Q 50/14; G06Q 30/06; G06Q 10/02

(52) U.S. Cl. CPC G06Q 30/0273; G06Q 30/0222; G06Q 30/0219; G06Q 50/01; G06Q 30/0641; G06Q 10/02; G06Q 50/14

(57) ABSTRACT

An online wedding coordination marketplace including a user interface created by a software algorithm stored in computer-readable non-transitory storage medium, where the user interface is displayed by a computing device that communicates through a communications network to access the algorithm, wherein the interface allows a user to search the offerings of vendors in the categories necessary to host a traditional wedding, where the user can find vendors that provide offerings in the desired wedding location, where the categories include at least: I) Wedding venues for hosting the wedding event and II) Caterers for supplying food at the wedding, and at least one of the additional categories including: A) Dress rental, B) Tuxedo rental, C) Wedding cake supply, D) Event decorations, E) DJ's for playing music at events, and F) Musicians, where the interface further sorts the offerings of vendors to show only offerings that the vendor can provide at a location the user has chosen, where the interface allows vendors to at least one of list and advertise their offerings, where the vendors must pay a fee in order to at least one of list and advertise their offerings, where the interface provides the user at least one of contact information to contact vendors and purchase the offerings from the vendors, and a checkout process to purchase offerings from the vendors through the interface. Preferably the online wedding coordination marketplace is designed to provide a unified service that a user planning a wedding can get most of the services, products, and rentals required to carry out a wedding event, while also providing sourcing, pricing, budgeting, assistance with planning and designing the wedding, and inviting guests; by providing these aspects in one service, a level of streamlining the planning, budgeting, sourcing, and execution of a wedding is achieved that has long been desired by millions of couples planning weddings, but has never been possible with the fragmented services that have previously existed and do not provide important features for streamlining such as pricing and sourcing of most of the aspects of the wedding in one location, which further provides the ability to budget and reduce the time required to set up the wedding, and features such as templates which greatly reduce the time required to plan and choose the various elements of the wedding and arrange the sourcing of these elements easily.

### BRIEF DESCRIPTION OF THE FIGURES

FIG. 1 is a schematic representation of the system of the first preferred embodiments.

FIG. 2 is a schematic representation of the system of the first preferred embodiments, including additional features such as templates, sending invites to guests, and budgeting.

### DESCRIPTION OF THE PREFERRED EMBODIMENTS

The description that follows of the invention's preferred embodiments is meant to enable someone skilled in the prior art to make and use the invention, but is not meant to limit the invention to these preferred embodiments.

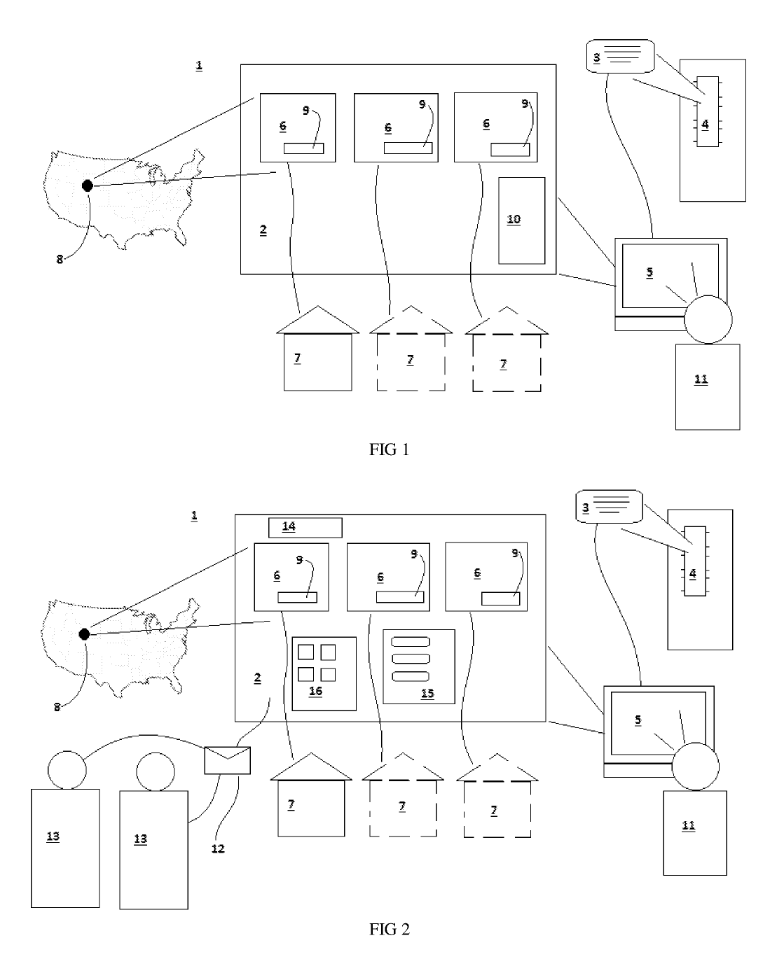

As shown in FIG. 1, the system of the preferred embodiments is an online wedding coordination marketplace 1 including a user 11 interface 2 created by a software algorithm 3 stored in computer-readable non-transitory storage medium 4, where the user 11 interface 2 is displayed by a computing device 5 that communicates through a communications network to access the algorithm 3, wherein the interface 2 allows a user 11 to search the offerings 6 of vendors 7 in the categories necessary to host a traditional wedding, where the user 11 can find vendors 7 that provide offerings 6 in the desired wedding location 8, where the categories include at least: I) Wedding venues for hosting the wedding event and II) Caterers for supplying food at the wedding, and at least one of the additional categories including: A) Dress rental, B) Tuxedo rental, C) Wedding cake supply, D) Event decorations, E) DJ's for playing music at events, and F) Musicians, where the interface 2 further sorts the offerings 6 of vendors 7 to show only offerings 6 that the vendor can provide at a location 8 the user 11 has chosen, where the interface 2 allows vendors 7 to at least one of list and advertise their offerings 6, where the interface 2 provides the user 11 at least one of contact information 9 to contact vendors 7 and purchase the offerings 6 from the vendors 7, and a checkout process 9 to purchase offerings 6 from the vendors 7 through the interface 2. Preferably the online wedding coordination marketplace 1 is designed to provide a unified service that a user 11 planning a wedding can get most of the services, products, and rentals required to carry out a wedding event, while also providing sourcing, pricing, budget 14ing, assistance with planning and designing the wedding, and inviting guests 13; by providing these aspects in one service, a level of streamlining the planning, budget 14ing, sourcing, and execution of a wedding is achieved that has long been desired by millions of couples planning weddings, but has never been possible with the fragmented services that have previously existed and do not provide important features for streamlining such as pricing and sourcing of most of the aspects of the wedding in one location 8, which further provides the ability to budget 14 and reduce the time required to set up the wedding, and features such as templates 16 which greatly reduce the time required to plan and choose the various elements of the wedding and arrange the sourcing of these elements easily. As such this system clearly introduces features over any prior art that have been needed for decades but have never before been offered in a system that appropriately addresses the central issue, which is coordination and sourcing of vendors 7, and comparing sets of options on price and overall design and experience. The online wedding coordination marketplace 1 may, however, be used for any suitable purpose.

As shown in FIG. 1, the online wedding coordination marketplace 1 preferably allows vendors 7 to list offerings 6 related to holding a wedding event, while also specifying what locations 8 they can provide these offerings 6 to, and the wedding coordination marketplace also allows a user 11 to search the offerings 6 of these vendors 7. For some offerings 6, a vendor may be able to ship or otherwise deliver the offering over a wide range of locations 8, while other offerings 6 may be fixed in location 8 or available in a small area, such as wedding venues or in person services. The online wedding coordination marketplace 1 shows offerings 6 across multiple categories necessary for hosting a wedding, which greatly streamlines a user's experience in planning and holding a wedding because it provides a single online service that a user 11 can turn to in order to research, source and purchase most of what they need to host a wedding; the alternative in the prior art has always required a user 11 to search many sources to determine the relevant options available in a location 8 across many categories, generally requiring open ended searching on internet search engines, searching in local phone books which the user 11 may not have ready access for, turning to limited listings available for certain categories of goods and services, and using wedding planners available in a certain area. This process is so vague, time consuming, complicated, hard to coordinate, and potentially difficult to budget 14 that many users 11 looking to hold a wedding turn to hiring paid wedding planners who are familiar with an area and have the time to carry out much of the process for them. This problem has existed for decades or longer and continues to persist despite all prior art services available today. Centralizing the majority of the offerings 6 necessary to hold a wedding in one place, as well as including sourcing information that allows a user 11 to purchase and arrange desired offerings 6 from vendors 7 that service the wedding location 8, creates the ability to provide previously unavailable services such as comprehensive budget 14ing which is enabled by the knowledge of specific vendors 7 and their offering pricing, and the ability to create templates 16 because multiple categories of offerings 6 are provided through one service. The two primary categories that are sourced for almost all weddings are a wedding venue, and catering to provide food and possibly beverages for the guests 13 of the wedding. The wedding venue can be for hosting the wedding itself, it can alternatively be for hosting the reception, and it can be for both the wedding and the reception, the user 11 would be provided with options and information related to pricing and purchasing a venue for at least one of these functions, which can include at least one of contact information 9 and a checkout process 9 allowing payment through the online marketplace. The system of the preferred embodiments preferably displays options in both of these two primary categories, along with pricing information and descriptions of the offerings 6 from the vendors 7 and at least one of contact information 9 for purchasing and a checkout process 9 that allows purchasing through the marketplace. In one variation, caterers may provide different menus with variations in pricing and pricing ranges depending on the number of guests 13. The online marketplace also provides options in at least one additional category out of the following categories: A) Dress rental, B) Tuxedo rental, C) Wedding cake supply, D) Event decorations, E) DJ's for playing music at events, and F) Musicians. These additional categories are not individually used at almost all weddings, but at least one of these categories is needed for the vast majority of weddings, and often more than one of these additional categories, so for this reason the online marketplace includes offerings 6 from vendors 7 in at least one of these additional categories. In another preferred variation, offerings 6 from all of these categories may be listed on the marketplace, based on which offerings 6 vendors 7 choose to list and which offerings 6 are listed in templates 16. In this preferred variation, the availability of these categories of offerings 6 in a given location 8 may vary based on the vendors 7 and templates 16 that list offerings 6 for a given region. Preferably the vendors 7 pay a fee to the online marketplace to be at least one of listed and advertised on the online wedding coordination marketplace 1, though in an alternate variation the vendors 7 may pay to the marketplace a percentage of the purchases they receive through the online marketplace. Because in a preferred variation there may be templates 16 loaded onto the online marketplace by third parties, where the templates 16 include sourcing information, it may not be possible to require all sourced vendors 7 to provide listing fees, however in this case revenue can be generated through at least one of taking a percentage of the purchase amounts, and through the sales of the templates 16. There may, however, be any suitable combination of vendors 7 and offerings 6 provided through the online marketplace and they may be chosen by any suitable method.

Vendors 7 may be allowed to advertise their offerings 6 by paying a fee to the marketplace to place an advertisement 10 on at least one area of the interface 2. In an alternate variation, vendors 7 may pay to elevate their position in search results on the interface 2. In an alternate variation, vendors 7 may be allowed to pay a fee to the marketplace to receive preferential listing among the offerings 6 on the marketplace. In an alternate variation, some of the offerings 6 may be listed on the site through being added by third parties in templates 16. These variations provide vendors 7 both chances to gain greater exposure and provide the marketplace opportunities to generate incoming revenue. The offerings 6 may be listed with individual pricing. In an alternative variation, vendors 7 may provide packages that have fixed prices but variable options within the packages. This variation may be advantageous for categories such as clothing rental and catering, where there are many options but it is desired to provide users 11 with pricing options before exact options are chosen. In this variation, encouraging offering packages streamlines the vendor's ability to close sales by having users 11 checkout with their packages through the marketplace, and it also allows users 11 the ability to price otherwise complicated offerings 6 that in the prior art might require visiting a vendor in person. This provides one of many ways that centralizing the offerings 6 into an online marketplace provides significant new advantages over the prior art. In another variation, offerings 6 may be priced by packaging or by individual item, depending on the choice of the vendor. There may, however, be any suitable means for vendors 7 to promote their offerings 6 on the online marketplace, or none at all. There may also be any suitable means for vendors 7 to price their offerings 6.

As shown in FIG. 2, in a preferred variation the online marketplace further provides a service for sending invitations 12 to at least two guests 13 that are to be invited to the wedding. Including invitation services with the online marketplace not only streamlines the process of planning the wedding, but also allows distributing other information generated by the online marketplace to invited guests 13. This additional information may include any of package hotel deals allowing the guests 13 to reserve hotel rooms at negotiated group rates, package car rental deals, a wedding gift registry 15 created by the user 11, jewelry store registries for rings and other jewelry, and including gifts the user 11 hopes to receive for their wedding, the opportunity for invited guests 13 to contribute money to the costs of the wedding, the opportunity for invited guests 13 to contribute money to the user's honeymoon travel plans, wedding updates, and any other suitable information. There may alternatively be no additional information distributed to invited guests 13. Wedding invitations 12 may be sent via electronic means, and they may also be sent via mailed wedding invitations 12. In one preferred variation, electronic means of sending wedding invitations 12 include at least one of social media messaging, e-mail, and text messaging. In a preferred variation, the online marketplace may interface 2 with at least one social network and allow the user 11 to communicate with connections they have in that social network through that social network. This may be carried out through at least one of APIs, by inviting those users 11 to enter contact information 9 with the online marketplace, and by using contact information 9 listed in the at least one social network. The online marketplace may also utilize other information available through communicating with the social network to perform any of the functions listed here, and any other suitable functions. In another preferred variation, mailed wedding invitations 12 may be sent as paper invitations 12 mailed through a postal service. In this variation, the user 11 pays to have the invitations 12 made and sent. In this variation, a user 11 can easily organize a guest list and have paper invitations 12 sent without significant additional work in printing and mailing the invitations 12. In another preferred variation, the online marketplace also provides seating layouts and allows the user 11 to easily place guests 13 based on the list of guests 13 that were invited through the online marketplace. In a variation of this variation, the list of invited guests 13 may be updated based on RSVP information, which may be automatically updated if electronic invitations 12 are used. In another variation of this variation, the venues may upload seating layout possibilities to the online marketplace for their venue, further streamlining the ability of the user 11 to create a seating layout directly for that venue. In a further variation of this variation, the seating layout may include an algorithm 3 that allows users 11 to introduce rules for guests 13 that they definitely want seated next to one another, and for guests 13 that they definitely want to sit separately, and the algorithm 3 may assist in providing automatically created layouts that satisfy these rules. In a further variation of this variation, the user 11 may choose the seating of some of the guests 13, and the algorithm 3 may automatically fill in the rest of the seating layout when the number of possibilities narrows due to the user's early manual choices. There may, however, be any suitable assistance in creating seating layouts. There may, however, be no aspect of the interface 2 that addresses seating layouts.

As shown in FIG. 2, in a preferred variation the user 11 may enter their budget 14 for the wedding. In this preferred variation, the user 11 selects offerings 6 for the wedding and inputs the number of guests 13 they intend to have at the wedding, and the algorithm 3 then calculates the cost of the selected offerings 6 for the input number of guests 13 and informs the user 11 if the offerings 6 they have selected fall within the budget 14 the user 11 input. In a further variation of this variation, the algorithm 3 calculates the quantity of money that the user's current selections are over budget 14, and then the algorithm 3 suggests categories in which the user 11 may be able to save the over budget 14 quantity of money. In some cases a large over budget 14 quantity of money will limit the categories in which the user 11 can save that quantity of money, so the algorithm 3 will guide the user 11. In other cases, the overrun may not be as significant, and the algorithm 3 may suggest similar offerings 6 to those that the user 11 has already selected, but which are lower cost in order to help the user 11 make their budget 14. This variation involving suggesting other offerings 6 similar to those that the user 11 has chosen can be carried out by recommending lower cost offerings 6 from the same category. In an alternate variation, data either input by users 11 or by vendors 7, or data tracked by user 11 activity may be used to determine which offerings 6 are similar to other offerings 6, and the algorithm 3 may use this information to recommend alternate offerings 6 that are lower cost to help users 11 come in on budget 14.

As shown in FIG. 2, in a preferred variation the marketplace allows the creation of event templates 16, where at least one of an individual and an organization can create a template 16 in the online marketplace, where the template 16 includes: AA) At least three decorations to be used in at least one of the wedding venue and the reception venue, BB) At least one caterer with at least one menu choice, CC) At least one option for at least one of a DJ to play music and a live musician, where the template 16 can be purchased by the user 11, where the template 16 includes purchase information and pricing for each of the offerings 6 in the template 16, where the at least one of an individual and an organization receives a portion of the purchase price of the template 16. In another preferred variation, the template 16 further includes at least one of: DD) At least one venue for at least one of the wedding and the wedding reception, EE) At least one of dress rental and tuxedo rental, and FF) At least one option for wedding cake supply. In the variation where the online marketplace allows the creation of templates 16, the templates 16 can be created by at least one of third party individuals and third party organizations, separate from the user 11 and from the vendors 7, which allows the creation of a marketplace where template 16 creation is a profit opportunity separately incentivized. This provides an opportunity for wedding planners and other individuals and organizations to profit by designing and sourcing wedding concepts one time, and then receiving revenue multiple times from the same template 16 without having to individually plan weddings, and it provides a marketplace for individuals and organizations to design and source weddings anywhere in the world. For the user 11, it provides the opportunity to quickly and inexpensively plan weddings with the assistance and skill of professionals, but without having to directly hire the services of a professional. It also allows users 11 to better view the end product that planning will result in than would be possible by directly hiring a wedding planner. In one preferred variation, the user 11 can view the template 16 but cannot access sourcing and purchase information without purchasing the template 16. Providing templates 16 allows a level of professional planning, design and coordination that has never before been available at the low costs and with the low planning time that are required with the availability of sourced templates 16. For an example, a template 16 might include one or more venue choices, a choice between a DJ and two live musicians, two different color schemes with table decorations and settings sourced and ready for purchase, four different sets of groomsmen clothing and bridesmaids dresses available for rent from two different suppliers and coordinated with the colors of the other options, seven different options for cakes from three different bakers, and three different options of menus from two different caterers, all with pricing readily available, with all offerings 6 designed to be visually and thematically fit together, and with all options sourced and available in the chosen wedding location 8. Because these options are all available, all designed to fit within a theme and certain color schemes, and the offerings 6 all include prices, this allows the templates 16 to list price ranges up front to help users 11 with budget 14ing, and when a user 11 selects specific offerings 6 from the template 16 it can all be ordered and arranged easily. In a preferred variation, at least some of the offerings 6 in the template 16 can be made available for checkout directly through the online marketplace and the user 11 can purchase and arrange those portions of the wedding easily, quickly, and straight through the online marketplace. This variation allows significant portions or even most of a wedding to be selected, sourced, arranged and ordered through the online marketplace quickly and easily, creating at least one of unprecedented savings in at least one of time and money for designing a wedding, and significant increases in the ability to design a wedding to a user's desires. In a preferred variation where the user 11 inputs a budget 14, the price ranges provided with the templates 16 can help the user 11 design and plan a wedding in their budget 14. In a further variation of this variation, the algorithm 3 can also help the user 11 select templates 16 that will fall into their budget 14, and may even help the user 11 select options within the templates 16 that will help them stay within their budget 14. There may, however, be any suitable design and arrangement of templates 16, and the templates 16 may include any suitable number of offerings 6 in any suitable categories. There may, however, be no templates 16 available on the online marketplace at all.

In one preferred variation, the user 11 may be able to create a gift registry 15 and upload gifts that they would like to receive from guests 13. In a variation of this variation, this gift registry 15 may be automatically shared with all invited guests 13. In another preferred variation, the online marketplace may provide the user 11 the ability to purchase travel services and travel bookings for a honeymoon. In this variation, the honeymoon travel plans and accommodations may be included in calculating the user's plans against their input budget 14. In a further variation, honeymoon plans may be available on the online marketplace in packages. In a variation of this variation, the invited guests 13 may be provided an opportunity to contribute money towards the honeymoon travel plans in order to help the user 11 go on the honeymoon they desire as a gift. In another preferred variation, the invited guests 13 may be provided the opportunity to contribute money towards the wedding plans directly.

In another preferred variation, additional services such as limo rental, entertainment services, entertainment rentals, gifts for wedding guests 13, and any other suitable aspects of a wedding may also be offered through the online wedding coordination marketplace 1. There may, however, be any suitable set of categories offered through the online wedding coordination marketplace 1.

As a person skilled in the art will recognize from the previous detailed description and from the figures and claims, modifications and changes can be made to the preferred embodiments of the invention without departing from the scope of this invention defined in the following claims.

I claim:

1) An online wedding coordination marketplace comprising a user interface created by a software algorithm stored in computer-readable non-transitory storage medium, wherein the user interface is displayed by a computing device that communicates through a communications network to access the algorithm, wherein the interface allows a user to search the offerings of vendors in the categories necessary to host a wedding, wherein the user can find vendors that provide offerings in the desired wedding location, wherein the categories comprise at least: I) Wedding venues for hosting the wedding event and II) Caterers for supplying food at the wedding, and at least one of the additional categories comprising: A) Dress rental, B) Tuxedo rental, C) Wedding cake supply, D) Event decorations, E) DJ's for playing music at events, and F) Musicians, wherein the interface further sorts the offerings of vendors to show only offerings that the vendor can provide at a location the user has chosen, wherein the interface allows vendors to at least one of list and advertise their offerings, wherein the interface provides the user at least one of contact information to contact vendors and purchase the offerings from the vendors, and a checkout process to purchase offerings from the vendors through the interface.

2) The online wedding coordination marketplace of claim 1, wherein the interface further provides a user the ability to send wedding invitations to at least two guests using at least one of electronic communication and mailed wedding invitations.

3) The online wedding coordination marketplace of claim 2, wherein the wedding invitations are sent using at least one of social media messaging, e-mail, and text messaging, wherein the vendors must at least one of 1) pay the marketplace a fee in order to at least one of list and advertise their offerings and 2) pay the marketplace a percentage of the purchases made through the site.

4) The online wedding coordination marketplace of claim 2, wherein the wedding invitations are sent as paper invitations through a postal service, and the user pays for the service.

5) The online wedding coordination marketplace of claim 2, wherein the interface is adapted to allow the user to input their budget for the wedding, wherein the user selects the options they desire for the wedding in each of the categories they choose, wherein the interface totals the prices for all of the selected options in each category and takes into account the number of guests input by the user and the interface then informs the user if the options the user has selected fall within the budget input by the user.

6) The online wedding coordination marketplace of claim 5, wherein if the options the user has selected exceed the budget input by the user, the algorithm calculates the categories where the user may save enough money to fit within the input budget, and shows alternate options in those categories to assist the user in having a set of selections that fall within the input budget.

7) The online wedding coordination marketplace of claim 3, wherein the marketplace is adapted to communicate with at least one social network and allow the user to send communications to contacts the user has established in the at least one social network.

8) The online wedding coordination marketplace of claim 1, wherein the marketplace allows the creation of event templates, wherein at least one of an individual and an organization can create a template in the marketplace, wherein the template comprises: AA) At least three decorations to be used in at least one of the wedding venue and the reception venue, BB) At least one caterer with at least one menu choice, CC) At least one option for at least one of a DJ to play music and a live musician, wherein the template can be purchased by the user, wherein the template includes purchase information and pricing for each of the offerings in the template, wherein the at least one of an individual and an organization receives a portion of the purchase price of the template.

9) The online wedding coordination marketplace of claim 8, wherein the template further comprises at least one of: DD) At least one venue for at least one of the wedding and the wedding reception, EE) At least one of dress rental and tuxedo rental, and FF) At least one option for wedding cake supply.

10) The online wedding coordination marketplace of claim 5, wherein the marketplace allows the creation of event templates, wherein at least one of an individual and an organization can create a template in the marketplace, wherein the template comprises: AA) At least three decorations to be used in at least one of the wedding venue and the reception venue, BB) At least one caterer with at least one menu choice, CC) At least one option for at least one of a DJ to play music and a live musician, wherein the template can be purchased by the user, wherein the template includes purchase information and pricing for each of the offerings in the template, wherein the at least one of an individual and an organization receives a portion of the purchase price of the template, wherein the template displays a price range for a given location based on the pricing of the vendors that supply that location, wherein the algorithm helps the user choose templates based on the user input budget.

11) The online wedding coordination marketplace of claim 6, wherein the marketplace allows the creation of event templates, wherein at least one of an individual and an organization can create a template in the marketplace, wherein the template comprises: AA) At least three decorations to be used in at least one of the wedding venue and the reception venue, BB) At least one caterer with at least one menu choice, CC) At least one option for at least one of a DJ to play music and a live musician, wherein the template can be purchased by the user, wherein the template includes purchase information and pricing for each of the offerings in the template, wherein the at least one of an individual and an organization receives a portion of the purchase price of the template, wherein the algorithm helps the user choose templates based on the user input budget, wherein the template is structured to allow the inclusion of more than one option in the template for at least one category.

12) The online wedding coordination marketplace of claim 1, wherein the user can also upload a gift registry and invited guests can purchase the gifts for the user.

13) The online wedding coordination marketplace of claim 9, wherein the user can also upload a gift registry and invited guests can purchase the gifts for the user.

14) The online wedding coordination marketplace of claim 1, wherein at least one of honeymoon travel accommodations, honeymoon travel flights, honeymoon travel activities, honeymoon travel packages, and honeymoon travel meals can also be purchased through the online wedding coordination marketplace through travel providers.

15) The online wedding coordination marketplace of claim 6, wherein at least one of honeymoon travel accommodations, honeymoon travel flights, honeymoon travel activities, honeymoon travel packages, and honeymoon travel meals can also be purchased through the online wedding coordination marketplace through travel providers, wherein the budget is also calculated with the honeymoon travel package.

16) The online wedding coordination marketplace of claim 9, wherein at least one of honeymoon travel accommodations, honeymoon travel flights, honeymoon travel activities, honeymoon travel packages, and honeymoon travel meals can also be purchased through the online wedding coordination marketplace through travel providers.

17) The online wedding coordination marketplace of claim 11, wherein at least one of honeymoon travel accommodations, honeymoon travel flights, honeymoon travel activities, honeymoon travel packages, and honeymoon travel meals can also be purchased through the online wedding coordination marketplace through travel providers, wherein the budget is also calculated with the honeymoon travel package.

18) The online wedding coordination marketplace of claim 17, wherein the template further includes at least one of: DD) At least one venue for at least one of the wedding and the wedding reception, EE) At least one of dress rental and tuxedo rental, and FF) At least one option for wedding cake supply.

19) The online wedding coordination marketplace of claim 16, wherein the interface further provides a user the ability to send wedding invitations to at least two guests, wherein the wedding invitations are sent using at least one of social media messaging, e-mail, and text messaging, wherein the invited guests are given the option of contributing money towards the honeymoon package that the user has selected.

20) The online wedding coordination marketplace of claim 11, wherein the interface further provides a user the ability to send wedding invitations to at least two guests, wherein the wedding invitations are sent using at least one of social media messaging, e-mail, and text messaging, wherein the invited guests can contribute money towards the wedding options the user has chosen in order to help fund the wedding.
